(19) United States
(12) Patent Application Publication
(10) Pub. No.: US 2026/0077266 A1
(43) Pub. Date: Mar. 19, 2026

(54) VIRTUAL OBJECT PLACEMENT METHOD AND APPARATUS, DEVICE, MEDIUM, AND PRODUCT

(71) Applicant: Tencent Technology (Shenzhen) Company Limited, Shenzhen (CN)

(72) Inventors: Tianqi BI, Shenzhen (CN); Yiming SUN, Shenzhen (CN)

(21) Appl. No.: 18/799,919

(22) Filed: Aug. 9, 2024

Related U.S. Application Data
(63) Continuation of application No. PCT/CN2023/126234, filed on Oct. 24, 2023.

(30) Foreign Application Priority Data
Dec. 7, 2022 (CN) 202211567703.3

(51) Int. Cl. A63F 13/5255; A63F 13/577; A63F 13/837

(52) U.S. Cl. CPC A63F 13/5255; A63F 13/577; A63F 13/837

(57) ABSTRACT

A virtual object placement method is performed by a computer device. The method includes: displaying a virtual object at a first placement position in a virtual scene in a first perspective direction of a virtual character; in response to receiving a perspective movement operation of the virtual character from the first perspective direction to a second perspective direction, displaying that the virtual object moves synchronously in the virtual scene from the first placement position to a second placement position corresponding to the second perspective direction according to the perspective movement operation, the virtual object moving, and the second placement position corresponding to the second perspective direction; and in response to receiving an object placement operation, placing the virtual object at an angle matching a plane performance feature of the second placement position relative to a supporting plane in the virtual scene when an

### CROSS-REFERENCE TO RELATED APPLICATIONS

The application is a continuation application of PCT Patent Application No. PCT/CN2023/126234, entitled “VIRTUAL OBJECT PLACEMENT METHOD AND APPARATUS, DEVICE, MEDIUM, AND PRODUCT” filed on Oct. 24, 2023, which claims priority to China Patent Application No. 202211567703.3, entitled “VIRTUAL OBJECT PLACEMENT METHOD AND APPARATUS, DEVICE, MEDIUM, AND PRODUCT” filed on Dec. 7, 2022, both of which are incorporated herein by reference in their entirety.

### FIELD OF THE TECHNOLOGY

This application relates to the field of computer technologies, and in particular, to a virtual object placement method and apparatus, a device, a medium, and a product.

### BACKGROUND OF THE DISCLOSURE

With the rapid development of computer technologies and diversification of terminals, electronic games have been gradually widely applied. In current three-dimensional animation games, generally, a terminal displays a three-dimensional virtual scene, and a user uses the terminal to control a virtual target to use a virtual item to perform activities in the three-dimensional virtual scene. For example, the virtual item is placed in the virtual scene.

In a related technology, a method for a user to place a virtual item in a three-dimensional virtual scene includes: determining a specified item and a placement position, and then placing the specified item at the placement position for display.

However, in the above related technology, the specified item is displayed in a fixed placement state at the placement position. As a result, the specified item does not fit the placement position, thereby leading to clipping. For example, after the specified item is placed, it is displayed that the specified item is in a wall-through state. In general, a game engine cannot determine a position and a state of a virtual item in which clipping occurs, resulting in erroneous calculations and a waste of computing resources.

### SUMMARY

Embodiments of this application provide a virtual object placement method and apparatus, a device, a medium, and a product, which can place a virtual object in a complex virtual environment in a posture matching a placement position, preventing clipping in the virtual object. The technical solutions are as follows:

According to one aspect of this application, a virtual object placement method is performed by a computer device and the method includes:
displaying a virtual object at a first placement position in a virtual scene in a first perspective direction of a virtual character;
in response to receiving a perspective movement operation of the virtual character from the first perspective direction to a second perspective direction, displaying that the virtual object moves synchronously in the virtual scene from the first placement position to a second placement position corresponding to the second perspective direction according to the perspective movement operation, the virtual object moving, and the second placement position corresponding to the second perspective direction; and
in response to receiving an object placement operation, placing the virtual object at an angle matching a plane performance feature of the second placement position relative to a supporting plane in the virtual scene when an object placement condition is met between the virtual object and the second placement position.

According to another aspect of this application, a computer device is provided, the computer device including a processor and a memory, the memory storing at least one instruction, at least one program, a code set, or an instruction set, and the at least one instruction, the at least one program, the code set, or the instruction set being loaded and executed by the processor and causing the computer device to implement the virtual object placement method in any one of the above embodiments of this application.

According to another aspect of this application, a non-transitory computer-readable storage medium is provided, storing at least one instruction, at least one program, a code set, or an instruction set, the at least one instruction, the at least one program, the code set, or the instruction set being loaded and executed by a processor of a computer device and causing the computer device to implement the virtual object placement method in any one of the above embodiments of this application.

The technical solutions provided in the embodiments of this application have at least the following beneficial effects:

In the process of displaying the virtual object at the first placement position in the virtual scene in the first perspective direction, when the perspective movement operation is received, as the perspective direction rotates from the first perspective direction to the second perspective direction, it is displayed that the virtual object moves synchronously with the rotation of the perspective direction and finally stays at the second placement position corresponding to the second perspective direction. If the object placement condition is met between the second placement position and the virtual object, after the object placement operation is received, the virtual object is placed at the angle matching the plane performance feature of the second placement position. On the one hand, the virtual object is simultaneously moved to the corresponding placement position through the rotation of the perspective direction, and the movement operation of the perspective direction is merged with the selection operation of the placement position, which improves efficiency of human-computer interaction during the placement of the virtual object. On the other hand, when the placement position meets the object placement condition, after the object placement operation is received, the virtual object is placed at an angle automatically matching the plane performance feature of the placement position, achieving automatic angle matching placement, so that the virtual object can adapt to a more complex virtual scene during the placement, preventing clipping in the virtual object and improving display authenticity during object placement.

### BRIEF DESCRIPTION OF THE DRAWINGS

FIG. 1 is a schematic diagram of an implementation environment according to an exemplary embodiment of this application.

FIG. 2 is a structural block diagram of an electronic device according to an exemplary embodiment of this application.

FIG. 3 is a flowchart of a virtual object placement method according to an exemplary embodiment of this application.

FIG. 4 is a flowchart of a virtual object placement method according to another exemplary embodiment of this application.

FIG. 5 is a schematic diagram of ray detection results according to an exemplary embodiment of this application.

FIG. 6 is a schematic diagram of a perspective ray detection process according to an exemplary embodiment of this application.

FIG. 7 is a schematic diagram of object collision detection according to another exemplary embodiment of this application.

FIG. 8 is a schematic diagram of display of a first placement effect according to another exemplary embodiment of this application.

FIG. 9 is a schematic diagram of display of a second placement effect according to an exemplary embodiment of this application.

FIG. 10 is a flowchart of a virtual object placement method according to another exemplary embodiment of this application.

FIG. 11 is a schematic diagram of a virtual object placement method according to an exemplary embodiment of this application.

FIG. 12 is a flowchart of a virtual object placement method according to another exemplary embodiment of this application.

FIG. 13 is a schematic diagram of parameter adjustment according to an exemplary embodiment of this application.

FIG. 14 is a structural diagram of a virtual object placement apparatus according to an exemplary embodiment of this application.

FIG. 15 is a structural diagram of a virtual object placement apparatus according to an exemplary embodiment of this application.

FIG. 16 is a structural diagram of a terminal according to an exemplary embodiment of this application.

### DESCRIPTION OF EMBODIMENTS

In a related technology, a method for a user to place a virtual item in a three-dimensional virtual scene includes: determining a specified item and a placement position, and then placing the specified item at the placement position for display. However, in the above related technology, the specified item is displayed in a fixed placement state at the placement position. As a result, the specified item does not fit the placement position, thereby leading to clipping. For example, after the specified item is placed, it is displayed that the specified item is in a wall-through state. In general, a game engine cannot determine a position and a state of a virtual item in which clipping occurs, resulting in erroneous calculations and a waste of computing resources.

An embodiment of this application provides a virtual object placement method. On the one hand, a virtual object is simultaneously moved to a corresponding placement position through rotation of a perspective direction, and a movement operation of the perspective direction is merged with a selection operation of the placement position, which improves efficiency of human-computer interaction during the placement of the virtual object. On the other hand, when the placement position meets an object placement condition, after an object placement operation is received, the virtual object is placed at an angle automatically matching a plane performance feature of the placement position, achieving automatic angle matching placement, so that the virtual object can adapt to a more complex virtual scene during the placement, preventing clipping in the virtual object and improving display authenticity during object placement.

User information (including, but not limited to, user equipment information, user personal information, and the like) and data (including, but not limited to, data for analysis, stored data, displayed data, and the like) involved in this application are information and data authorized by users or fully authorized by all parties, and collection, use, and processing of relevant data need to comply with relevant laws, regulations, and standards of relevant countries and regions. For example, object behaviors such as a perspective movement operation and an object placement operation involved in this application are all acquired with full authorization.

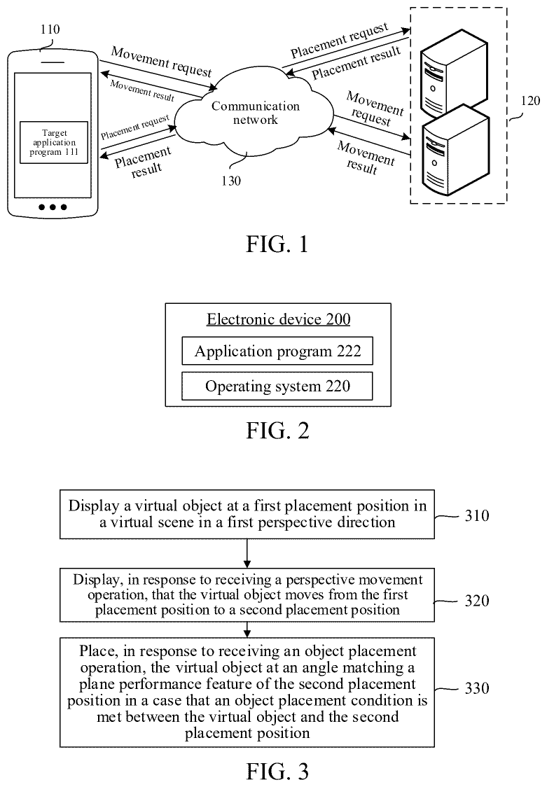

Firstly, an implementation environment of this application is introduced. FIG. 1 is a schematic diagram of an implementation environment according to an exemplary embodiment of this application. The implementation environment includes: a terminal 110, a server 120, and a communication network 130. The terminal 110 and the server 120 are connected through the communication network 130.

A target application program 111 is installed and run in the terminal 110. The target application program 111 is an application program supporting a two-dimensional virtual environment or a three-dimensional virtual environment. The target application program 111 may be any one of a virtual reality application program, a three-dimensional map program, an auto chess game, a strategy game, a third-person shooting (TPS) game, a first-person shooting (FPS) game, a multiplayer online battle arena (MOBA) game, and a multiplayer shooting survival game. In an implementation, the target application program 111 may be a standalone application program such as a standalone three-dimensional game application program, or may be a network online application program.

In some embodiments, when the target application program is implemented as the standalone application program, a virtual object at a first placement position in a virtual scene is currently displayed in a first perspective direction in a running interface of the target application program. When the terminal receives a perspective movement operation, as the terminal displays that a perspective direction rotates from the first perspective direction to a second perspective direction, the virtual object synchronously moves from a first placement position to a second placement position along with the rotation of the perspective direction.

The second placement position corresponds to the second perspective direction. If the terminal detects that the second placement position meets an object placement condition, when the terminal receives an object placement operation, the terminal displays a process of placing the virtual object at an angle matching a plane performance feature of the second placement position.

In some embodiments, when the target application program is implemented as the network online application program, as shown in FIG. 1, the target application program 111 is currently implemented as a battle game (such as a TPS game or an FPS game), and the terminal 110 displays the virtual object in the virtual scene in the first perspective direction during running of the target application program 111. When receiving the perspective movement operation, the terminal 110 generates a movement request and feeds the movement request back to the server 120. The movement request is configured to request moving a perspective direction in which the virtual scene is observed and moving a placement position of the virtual object. The movement request includes a direction parameter of the second perspective direction and a position parameter of the second placement position.

After receiving the movement request, the server 120 retrieves, according to the direction parameter in the movement request, a picture rendering parameter corresponding to the direction parameter in a rendering file stored in the server, and detects a placement condition of the second placement position according to the virtual object to obtain a placement result corresponding to the virtual object. If the object placement condition is met between the virtual object and the second placement position, the placement result corresponding to the virtual object is a first placement result. The first placement result is to retrieve an effect rendering parameter corresponding to a first placement effect. If the object placement condition is not met between the virtual object and the second placement position, the placement result corresponding to the virtual object is a second placement result. The second placement result is to retrieve an effect rendering parameter corresponding to a second placement effect. The first placement effect is different from the second placement effect. A movement result generated from the effect rendering parameter and the picture rendering parameter is fed back to the terminal 110.

After receiving the movement result, the terminal 110 performs picture rendering on the virtual scene according to the picture rendering parameter in the movement result, displays an animation in which an observation perspective for the virtual scene is rotated from the first perspective direction to the second perspective direction, renders the virtual object according to the effect rendering parameter, and displays a placement effect corresponding to the virtual object when the placement position of the virtual object moves synchronously along with the perspective direction.

When the terminal 110 displays the first placement effect corresponding to the virtual object, it indicates that the second placement position meets the object placement condition. When the terminal 110 receives the object placement operation, a placement request is generated and transmitted to the server 120. The placement request is configured to request placing the virtual object at the second placement position.

After receiving the placement request, the server 120 acquires a plane performance feature corresponding to the second placement position from a plane performance feature data file, calculates a placement angle parameter of the virtual object according to the plane performance feature corresponding to the second placement position, generates a placement rendering parameter based on the placement angle parameter, and feeds the placement rendering parameter back to the terminal 110 as the placement result.

After receiving the placement result, the terminal 110 renders a picture according to the placement rendering parameter, thereby displaying the picture in which the virtual object is placed at an angle matching the plane performance feature of the second placement position.

The terminal 110 may be optional. The terminal may be a terminal device in various forms such as a desktop computer, a portable laptop computer, a mobile phone, a tablet computer, an ebook reader, a moving picture experts group audio layer III (MP3) player, a moving picture experts group audio layer IV (MP4) player, a smart television, a smart in-vehicle device, and the like, which is not limited in this embodiments of this application. The server 120 includes at least one of one server, a plurality of servers, a cloud computing platform, and a virtualization center. In some embodiments, the server 120 takes on primary computing work, and the terminal 110 takes on secondary computing work. Alternatively, the server 120 takes on the secondary computing work, and the terminal 110 takes on the primary computing work. Alternatively, collaborative computing is performed between the server 120 and the terminal 110 by using a distributed computing architecture.

The server may be an independent physical server, or a server cluster or a distributed system formed by a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology refers to a hosting technology that unifies hardware, software, network, and other series of resources in a wide area network or a local area network to realize data calculation, storage, processing, and sharing.

In some embodiments, the server 120 may alternatively be implemented as a node in a blockchain system.

FIG. 2 is a structural block diagram of an electronic device according to an exemplary embodiment of this application. The electronic device 200 includes: an operating system 220 and an application program 222.

The operating system 220 is basic software that provides the application program 222 with secure access to computer hardware.

The application program 222 is an application program supporting a virtual environment. In some embodiments, the application program 222 is an application program supporting a three-dimensional virtual environment. The application program 222 may be any one of a virtual reality application program, a three-dimensional map program, a TPS game, an FPS game, a MOBA game, a multiplayer shooting survival game, a puzzle game, and a strategy game. The application program 222 may be a standalone application program, such as a standalone game application program, or may be a network online application program.

The virtual object placement method provided in this application is described in combination with the above introduction. The method may be performed by a server or a terminal or jointly by the server and the terminal. In this embodiment of this application, for example, the method is performed by the terminal. As shown in FIG. 3, the method includes the following operations.

Operation 310: Display a virtual object at a first placement position in a virtual scene in a first perspective direction.

The virtual object is an object in the virtual scene on which placement position adjustment is to be performed. The first placement position corresponds to the first perspective direction.

Illustratively, a target application program is run in the terminal. The target application program may be any one of a virtual reality application program, a three-dimensional map program, an auto chess game, a strategy game, a TPS game, an FPS game, a MOBA game, a multiplayer shooting survival game, and the like.

In some embodiments, the virtual scene is a display scene in a running interface corresponding to the target application program run in the terminal.

In some embodiments, the virtual scene is a three-dimensional virtual scene, or the virtual scene is a two-dimensional virtual scene, which is not limited.

In some embodiments, in the process of currently displaying the virtual object in the virtual scene in the first perspective direction, the first perspective direction includes a first perspective direction corresponding to a first-person perspective; or the first perspective direction includes a first perspective direction corresponding to a third-person perspective, which is not limited.

When the first perspective direction is implemented as the perspective direction of the first-person perspective, in the virtual scene, the virtual object is displayed, but a main control virtual target is not displayed. When the first perspective direction is implemented as the perspective direction of the third-person perspective, in the virtual scene, the virtual object is displayed, and the main control virtual target is displayed.

In some embodiments, in the first-person perspective, the first perspective direction refers to a shooting direction in which a virtual camera is set up at a perspective position of the main control virtual target (e.g., eyes) to shoot the virtual scene, and a scene picture of the virtual scene is displayed according to a shooting picture. In the third-person perspective, the third perspective direction refers to a shooting direction in which a virtual camera is set up at a perspective position of the main control virtual target (e.g., a position above a head of the main control virtual target) to shoot the virtual scene, and a scene picture of the virtual scene is displayed according to a shooting picture.

In some embodiments, the virtual object is an object originally existing in the virtual scene, such as a virtual carrier or a virtual item; or the virtual object is an object owned by the main control virtual target. For example, the virtual object is an object taken out by the main control virtual target from a virtual backpack.

In some embodiments, the first placement position refers to a position in the virtual scene. For example, in a virtual scene picture currently displayed in the first perspective direction, the virtual object is placed on a ground. Alternatively, the first placement position refers to a position on the main control virtual target. For example, in a virtual scene picture currently displayed in the first perspective direction, the virtual object is placed on a hand of the main control virtual target.

In some embodiments, a distance between the virtual object and the perspective position of the main control virtual target is fixed. That is, the virtual object is always displayed at a position at a fixed distance from the perspective position. Alternatively, the distance between the virtual object and the perspective position of the main control virtual target may be set according to will of a user. If the user sets a shorter distance, the virtual object currently displayed in the virtual scene has a larger size, indicating that the virtual object is closer to the perspective position of the main control virtual target. If the user sets a longer distance, the virtual object currently displayed in the virtual scene has a smaller size, indicating that the virtual object is farther from the perspective position of the main control virtual target.

In some embodiments, placement position adjustment is performed in at least one of the following manners:

1. The user controls the movement of the perspective direction of the main control virtual target to control, in real time, the virtual object to perform position movement in the virtual scene to realize placement position adjustment on the virtual object.

2. The user controls the main control virtual target to move in the virtual scene. As the main control virtual target moves, the virtual object moves with the movement of the main control virtual target to realize placement position adjustment.

3. The user selects a specified position in the virtual scene, and after the selection of the specified position, the virtual object automatically moves from the first placement position to the specified position to realize placement position adjustment.

The above description of the manner of placement position adjustment is merely exemplary, which is not limited in this embodiment of this application.

Illustratively, the main control virtual target refers to a virtual target that controls actions of a target account currently logged on to the terminal.

In some embodiments, “the first placement position corresponds to the first perspective direction” means that the first placement position is in a specified region in a virtual scene picture obtained by observing the virtual environment in the first perspective direction. For example, the virtual object at the first placement position in the virtual scene is currently displayed in the first perspective direction. The first placement position is located in a center of the current virtual scene picture.

Operation 320: Display, in response to receiving a perspective movement operation, that the virtual object moves from the first placement position to a second placement position.

The perspective movement operation is configured to rotate a perspective direction in which the virtual scene is observed from the first perspective direction to a second perspective direction, the virtual object moves synchronously in the virtual scene along with rotation of the perspective direction, and the second placement position corresponds to the second perspective direction.

In some embodiments, the perspective movement operation refers to an operation of controlling the main control virtual target to be adjusted from the first perspective direction to the second perspective direction.

Illustratively, the perspective direction refers to a perspective vector generated in a specified direction with the perspective position of the main control virtual target as a vector starting point. Namely, a virtual scene picture displayed in the perspective direction refers to a perspective region range generated according to the perspective vector, thereby displaying a scene picture within the perspective region range. Therefore, as long as the main control virtual target changes the perspective position, the corresponding perspective direction may change accordingly. The perspective position is changed in at least one of the following manners: moving the main control virtual target, rotating the head of the main control virtual target, adjusting a posture of the main control virtual target, and the like.

In some embodiments, the perspective movement operation includes at least one of the following operation manners:

1. The perspective direction of the main control virtual target is adjusted by rotating a perspective of the main control virtual target. For example, the first perspective direction of the main control virtual target is currently to look forward horizontally based on a position of the main control virtual target. After the perspective of the main control virtual target is controlled to rotate to the right by 90 degrees, the second perspective direction of the main control virtual target is to look right horizontally.

The perspective of the main control virtual target may be rotated by mouse movement, a mouse wheel, keyboard control, control by a control (such as a joystick control), or other operations, which is not limited in this embodiment of this application.

2. The perspective direction of the main control virtual target is adjusted by moving the position of the main control virtual target. For example, the first perspective direction of the main control virtual target in the virtual scene is currently a north direction.

After the main control virtual target is controlled to turn west and then move forward by a certain distance, the second perspective direction of the main control virtual target is currently a west direction.

3. A perspective adjustment interface is displayed in a display interface of the terminal, and a specified perspective direction parameter is entered into the perspective adjustment interface, so that the main control virtual target is adjusted from the first perspective direction to the entered specified perspective direction parameter. If the first perspective direction is currently the north direction, when “turn east by 45 degrees” is entered into the perspective adjustment interface, the perspective direction of the main control virtual target is turned from north to east by 45 degrees and then a northeast direction is displayed as the second perspective direction.

4. A perspective adjustment progress bar is displayed in the display interface of the terminal, and an adjustment operation on the perspective adjustment progress bar is received, so that the perspective direction of the main control virtual target is adjusted from the first perspective direction to the corresponding perspective direction.

The above description of the perspective movement operation is merely exemplary, which is not limited in this embodiment of this application.

For a first implementation of the above perspective movement operation, the perspective is rotated by rotating left, right, up, down, forward, backward, or in other directions.

In some embodiments, during the rotation of the perspective direction of the main control virtual target, the placement position of the virtual object synchronously moves accordingly.

In some embodiments, in response to receiving the perspective movement operation, it is displayed based on a perspective rotation angle corresponding to the perspective movement operation that the virtual object moves from the first placement position to the second placement position. The perspective rotation angle is positively correlated with a position movement distance between the first placement position and the second placement position.

Illustratively, a movement distance of the placement position of the virtual object corresponds to a rotation angle of the perspective direction. For example, each time the perspective direction is rotated by 30 degrees, the virtual object synchronously moves by 10 cm in the virtual scene. In this case, moving by 10 cm is based on the distance in the virtual scene.

In some embodiments, in response to receiving the perspective movement operation, it is displayed based on a perspective rotation speed corresponding to the perspective movement operation that the virtual object moves from the first placement position to the second placement position. The perspective rotation speed is positively correlated with the position movement distance between the first placement position and the second placement position.

Illustratively, the movement distance of the placement position of the virtual object corresponds to a rotation speed of the perspective direction. For example, When the rotation speed of the main control virtual target is faster, the virtual object moves by a longer distance in the virtual scene.

A movement distance of the virtual object in the virtual scene is determined based on the perspective rotation angle or the perspective rotation speed, so that the movement distance of the virtual object in the virtual scene is synchronized with a perspective rotation direction and processes of rotation and movement are coordinated with each other. Therefore, the position movement process of the virtual object presents a more natural and smooth movement effect.

In some embodiments, the second placement position refers to a position of the virtual object in the virtual scene after moving from the first perspective direction to the second perspective direction.

In some embodiments, a distance between the second placement position and the perspective position of the main control virtual target is equal to a distance between the first placement position and the perspective position of the main control virtual target. Namely, in this situation, a perspective distance of the main control virtual target to the virtual object is a fixed value.

In some embodiments, “the second placement position corresponds to the second perspective direction” means that the second placement position is in a specified region in a virtual scene picture obtained by observing the virtual environment in the second perspective direction. For example, the virtual object at the second placement position in the virtual scene is currently displayed in the second perspective direction. The second placement position is located in a center of the current virtual scene picture.

In some embodiments, a corresponding relationship between the first placement position and the first perspective direction is the same as a corresponding relationship between the second placement position and the second perspective direction, for example, the first placement position is located in the center of the virtual scene picture displayed in the first perspective direction, and the second placement position is located in the center of the virtual scene picture displayed in the second perspective direction; or the corresponding relationship between the first placement position and the first perspective direction is different from the corresponding relationship between the second placement position and the second perspective direction, for example, the first placement position is located in the center of the virtual scene picture displayed in the first perspective direction, and the second placement position is located on a left side of the virtual scene picture displayed in the second perspective direction, which is not limited.

Operation 330: Place, in response to receiving an object placement operation, the virtual object at an angle matching a plane performance feature of the second placement position when an object placement condition is met between the virtual object and the second placement position.

Illustratively, the object placement condition refers to a condition under which the virtual object can be placed at the second placement position without clipping. Clipping refers to display of partial intersection between the virtual object and another object. For example, the virtual object passes through a wall, or two virtual objects overlap.

In some embodiments, the object placement operation refers to an operation of controlling the main control virtual target to place the virtual object at the second placement position.

In some embodiments, the object placement condition includes at least one of the following two conditions:

1. The object placement condition includes a plane placement condition. The plane placement condition includes at least one of whether a region area of a plane where the second placement position is located meets a preset area requirement, whether plane flatness meets a preset flatness requirement, whether the second placement position belongs to a position on the plane.

Taking whether the region area of the plane where the second placement position is located meets the preset area requirement as an example, when the region area of the plane where the second placement position is located is greater than or equal to a minimum placement area required by the virtual object, it indicates that the second placement position meets the plane placement condition. When the region area of the plane where the second placement position is located is less than the minimum placement area required by the virtual object, it indicates that the second placement position does not meet the plane placement condition.

Taking whether the plane flatness of the plane where the second placement position is located meets the preset flatness requirement as an example, when the plane flatness of the plane where the second placement position is located meets a flatness requirement required by the virtual object (e.g., the plane is a relatively flat ground), it indicates that the second placement position meets the plane placement condition. When the plane flatness of the plane where the second placement position is located does not meet the flatness requirement required by the virtual object (e.g., the plane is a mountain with large undulations), it indicates that the second placement position does not meet the plane placement condition.

Taking whether the second placement position belongs to the position on the plane as an example, if the second placement position belongs to the position on the plane, it indicates that the second placement position meets the plane placement condition. If the second placement position is at a suspended position (which neither belongs to any plane nor is in contact with any plane) or at a position below the plane (e.g., the second placement position is 3 cm below a soil slope), it indicates that the second placement position does not meet the plane placement condition.

2. The object placement position includes an obstacle placement condition, that is, a situation of an obstacle placed within a region range corresponding to the second placement position. If no obstacle exists within the region range corresponding to the second placement position or an obstacle exists but the virtual object may not intersect with the obstacle for display when placed at the second placement position, it indicates that the second placement position meets the obstacle placement condition. If an obstacle exists within the region range corresponding to the second placement position but the virtual object may intersect with the obstacle for display when placed at the second placement position, it indicates that the second placement position does not meet the obstacle placement condition.

The above content of the object placement condition is merely exemplary, which is not limited in this embodiment of this application.

In some embodiments, a distance between the second placement position and the perspective position of the main control virtual target is equal to a distance between the first placement position and the perspective position of the main control virtual target; or the distance between the second placement position and the perspective position of the main control virtual target is different from the distance between the first placement position and the perspective position of the main control virtual target.

In an implementable solution, when the distance between the second placement position and the perspective position of the main control virtual target is different from the distance between the first placement position and the perspective position of the main control virtual target, the user may adjust the distance between the second placement position and the perspective position of the main control virtual target according to a requirement.

In some embodiments, after the object placement operation is received, a plane performance feature of the second placement position is acquired, a placement angle of the virtual object is determined according to the plane performance feature, and it is finally displayed that the virtual object is placed at the second placement position at the placement angle.

In some embodiments, the plane performance feature of the second placement position includes at least one of performance feature types such as a region area of the plane where the second placement position is located, an inclination angle of the plane based on the ground in the virtual scene, and plane friction.

The region area is configured to determine a placement posture of the virtual object at the second placement position. In some embodiments, based on the region area of the plane where the second placement position is located and areas of a plurality of contact surfaces of the virtual object, a target contact surface is determined from the plurality of contact surfaces; and the virtual object is placed at the second placement position based on the inclination angle and the target contact surface, and the target contact surface of the virtual object fits the plane where the second placement position is located. For example, if the virtual object is a cuboid, a bottom surface of the virtual object is currently 10 square centimeters, a side face is 5 square centimeters, and the region area is 6 square centimeters, finally the virtual object is placed at the second placement position by taking the side face as a new bottom surface and the new bottom surface fits the plane where the second placement position is located.

After a contact surface matching the plane where the second placement position is located is determined, the contact surface is taken as a fitting surface to fit the plane where the second placement position is located, which reduces, to some extent, a situation where the contact surface is larger than the region area, so that the placement operation of the virtual object is more reasonable.

The inclination angle of the plane based on the ground in the virtual scene is configured to determine a placement angle of the virtual object. For example, when an inclination angle of the plane where the second placement position is located based on the ground is 45 degrees, finally, the virtual object is also obliquely placed at the second placement position at an angle of 45 degrees.

The plane friction is configured to determine a placement state of the virtual object after the virtual object is placed at the second placement position. In some embodiments, when the plane friction meets a friction requirement, an object sliding animation is displayed. The object sliding animation is an animation in which the virtual object slides on the plane where the second placement position is located. For example, if the plane where the second placement position is located is a smooth plane, the plane friction is approximately 0. After the virtual object is placed at the second placement position, the virtual object may slide downwards if the second placement position is a slope.

When the virtual object is placed on the plane where the second placement position is located, it may be displayed that the virtual object slides on the plane where the second placement position is located if the friction requirement is met between the plane where the second placement position is located and the virtual object, which improves physical reality of the virtual object in the virtual scene and improves gaming experience of a player.

In some embodiments, the angle matching the plane performance feature of the second placement position is automatically determined by the server after receiving the object placement operation; or the angle matching the plane performance feature of the second placement position is determined by the user by manually adjusting the placement posture of the virtual object.

In some embodiments, the virtual object corresponds to different display states in different placement states.

Illustratively, the virtual object corresponds to different display states respectively during the placement position adjustment and after the end of the placement process. In an example, a silhouette effect is displayed during the placement position adjustment of the virtual object, and after the virtual object is placed at an angle fitting the plane performance feature of the second placement position, the virtual object displays an actual effect.

Different states of the virtual object are displayed in different placement states, so that the player can understand an adjustment stage of the virtual object through the displayed states, improving efficiency of human-computer interaction.

In some embodiments, the virtual object corresponds to a same display state respectively during the placement position adjustment and after the end of the placement process.

Based on the above, according to the virtual object placement method provided in this embodiment of this application, in the process of displaying the virtual object at the first placement position in the virtual scene in the first perspective direction, when the perspective movement operation is received, as the perspective direction rotates from the first perspective direction to the second perspective direction, it is displayed that the virtual object moves synchronously with the rotation of the perspective direction and finally stays at the second placement position corresponding to the second perspective direction. If the object placement condition is met between the second placement position and the virtual object, after the object placement operation is received, the virtual object is placed at the angle matching the plane performance feature of the second placement position. On the one hand, the virtual object is simultaneously moved to the corresponding placement position through the rotation of the perspective direction, and the movement operation of the perspective direction is merged with the selection operation of the placement position, which improves efficiency of human-computer interaction during the placement of the virtual object. On the other hand, when the placement position meets the object placement condition, after the object placement operation is received, the virtual object is placed at an angle automatically matching a plane performance feature of the placement position, achieving automatic angle matching placement, so that the virtual object can adapt to a more complex virtual scene during the placement, preventing clipping in the virtual object and improving display authenticity during object placement.

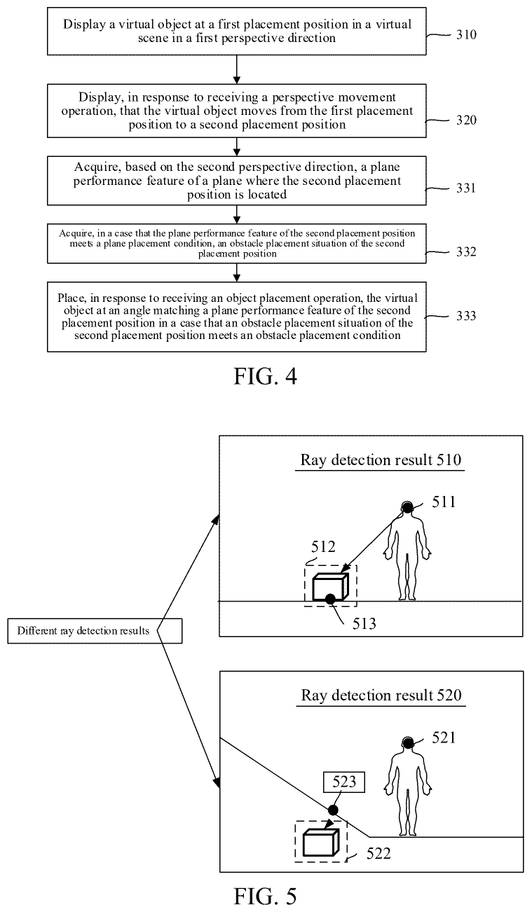

In some embodiments, a manner of determining whether the second placement position meets the object placement condition includes performing perspective ray detection and object collision detection processes on the second placement position. Illustratively, refer to FIG. 4 which is a flowchart of a virtual object placement method according to an exemplary embodiment of this application. To be specific, operation 330 further includes operation 331 to operation 333. As shown in FIG. 4, the method includes the following operations.

Operation 331: Acquire, based on the second perspective direction, a plane performance feature of a plane where the second placement position is located.

In some embodiments, the second placement position refers to a position of the virtual object in the virtual scene after moving from the first perspective direction to the second perspective direction.

Illustratively, the plane performance feature of the second placement position is determined according to a perspective vector generated from the second perspective direction. The plane performance feature includes at least one of performance features such as whether the second placement position belongs to a position on the plane, a position region range of the second placement position, and an inclination angle of the second placement position based on the ground.

In some embodiments, a perspective position of a main control virtual target in the virtual scene is acquired; perspective ray detection is performed on the second placement position based on the perspective position and the perspective direction to obtain a ray detection result corresponding to the second placement position, the ray detection result being configured to indicate existence of an intersection point between the plane where the second placement position is located and the perspective direction; and the plane performance feature of the second placement position is obtained based on the ray detection result.

Illustratively, the perspective position refers to position coordinates of the perspective of the main control virtual target in the virtual scene. In the first-person perspective, the perspective position is implemented as a specified position on the main control virtual target. For example, a head perspective of the main control virtual target is taken as the perspective position. In another example, a chest perspective of the main control virtual target is taken as the perspective position. In the third-person perspective, the perspective position is implemented as a specified position above the main control virtual target, which is not limited.

In this embodiment, a perspective distance of the main control virtual target is determined by taking the perspective of the main control virtual target as a starting point and according to a distance from a plane of a ground where the main control virtual target is located. For example, in the first-person perspective, if an eye position of the main control virtual target is taken as the perspective position and a distance from the eye position to the ground where the main control virtual target is located is 1.5 m in the virtual scene, the perspective position of the main control virtual target in the virtual scene is “1.5 m above the ground.”

Illustratively, for example, the distance between the virtual object and the perspective position is a preset fixed distance (a line-of-sight distance). The perspective vector is generated according to the perspective direction by taking the perspective position of the main control virtual target as a vector starting point and the position of the virtual object as a vector ending point, and perspective ray detection on the second placement position is realized through the perspective vector.

The perspective ray detection means detecting, through the perspective vector, whether there is an intersection point between the vector ending point of the perspective vector and the second placement position. Therefore, the ray detection result includes two different results: there is an intersection point and there is no intersection point. When the ray detection result is that there is an intersection point, it indicates that there is an intersection point between the vector ending point and the second placement position. In this case, the second placement position meets a condition for passing the perspective ray detection, and object collision detection may be performed thereon subsequently. If the object collision detection is passed, the virtual object may be placed at the second placement position with a correct posture. When the ray detection result is that there is no intersection point, it indicates that there is no intersection point between the vector ending point and the second placement position. In this case, there are two situations. In one situation, there is no intersection point between the perspective vector and the second placement position. In this case, if the virtual object is placed at the second placement position, the virtual object may be “suspended”. In the other situation, there is an intersection point between a point on the perspective vector and the second placement position. To be specific, in this case, if the virtual object is placed at the second placement position, “sinking” may occur. Therefore, when there is no intersection point between the vector ending point and the second placement position currently, clipping or a suspended state may occur when the virtual object is placed at the second placement position. To be specific, the intersection point between the plane where the second placement position is located and the perspective direction includes: the second placement position just intersecting the vector ending point, the intersection point between the plane where the second placement position is located and the perspective direction being located below the vector ending point (in this case, the virtual object is in the suspended state), and the intersection point between the plane where the second placement position is located and the perspective direction being located above the vector ending point (in this case, the virtual object is in a sunken state).

Illustratively, refer to FIG. 5 which is a schematic diagram of ray detection results according to an exemplary embodiment of this application. As shown in FIG. 5, a ray detection result 510 and a ray detection result 520 are currently displayed. In the ray detection result 510, a perspective position 511 of the main control virtual target and a vector ending point 512 obtained according to the virtual object are currently displayed. In this case, there is an intersection point between the vector ending point 512 and a second placement position 513. Namely, in this case, the vector ending point 512 and the second placement position 513 belong to a same position. In the ray detection result 520, the perspective position 521 of the main control virtual target and the vector ending point 522 obtained according to the virtual object are currently displayed. In this case, there is no intersection point between the vector ending point 522 and the second placement position 523. Namely, the vector ending point 522 and the second placement position 523 belong to different positions.

In some embodiments, since the distance between the virtual object and the main control virtual target is a fixed line-of-sight distance, as the perspective direction of the main control virtual target moves, the perspective vector changes accordingly. Therefore, a perspective range circle is generated by taking the perspective position of the main control virtual target as a center of a circle and the line-of-sight distance as a radius. A perspective range region of the main control virtual target in the perspective range circle is determined according to the second perspective direction, and perspective ray detection is performed on the second placement position according to the perspective range region, thereby determining a plane intersection result between the second placement position and the perspective range region as the ray detection result. The plane intersection result includes the second placement position intersecting an edge point of the perspective region range (i.e., the vector ending point of the perspective vector), there being no intersection point between the second placement position and the perspective region range, and the second placement position intersecting a point in the perspective region range. To be specific, a line-of-sight distance between the perspective position and the virtual object is acquired; a perspective range region of the main control virtual target is generated based on the second perspective direction by taking the perspective position as a center of a circle and the line-of-sight distance as a radius; and perspective ray detection is performed on the second placement position based on the perspective range region to obtain a plane intersection result between the plane where the second placement position is located and the perspective range region, and the plane intersection result is taken as the ray detection result.

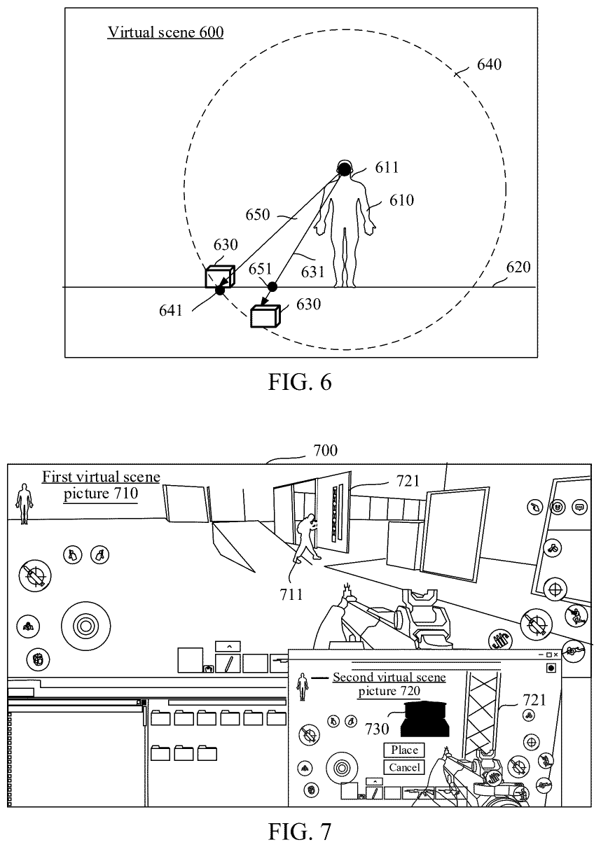

Illustratively, refer to FIG. 6 which is a schematic diagram of a perspective ray detection process according to an exemplary embodiment of this application. As illustrated, a virtual scene 600 is currently displayed, and the virtual scene includes a main control virtual target 610, and a ground 620 of the main control virtual target 610, a perspective position 611 of the main control virtual target 610, and a line-of-sight distance 631 between the main control virtual target 610 and a virtual object 630 are acquired, so as to generate a perspective range circle 640 with the perspective position 611 as a center of a circle and the line-of-sight distance as a radius. In this case, a perspective vector 650 is generated according to the second perspective direction. When there is an intersection point between a point on the perspective range circle 640 and a second placement position 641, the plane intersection result “there is an intersection point” is obtained. In this case, the plane placement condition is met. When a perspective direction of the main control virtual target 610 rotates downwards from the second perspective direction to the third perspective direction, the virtual object 630 moves from the second placement position 641 to a third placement position 651, and a perspective vector is generated. As can be seen from FIG. 6, in this case, there is no intersection point between the third placement position 651 and the perspective range circle 640. Therefore, the plane intersection result is “there is no intersection point”. In this case, the plane placement condition is not met.

The above is implemented based on a condition that the line-of-sight distance between the virtual object and the perspective position is a fixed distance. In another implementable solution, the line-of-sight distance between the virtual object and the perspective position may be adjusted in real time according to a ray detection result. Namely, the line-of-sight distance currently between the virtual object and the perspective position is an initial line-of-sight distance. After the perspective position of the main control virtual target is determined, a detection ray is emitted in the second perspective direction of the main control virtual target by taking the perspective position as a starting point. When the detection ray hits a specified plane in the virtual scene and generates an intersection point with the specified plane, the intersection point is taken as the second placement position, the specified plane is taken as the plane where the second placement position is located, and the initial line-of-sight distance between the virtual object and the perspective position is adjusted to the distance between the second placement position and the perspective position. When the detection ray does not intersect any plane in the virtual scene, the second placement position is a position at the initial line-of-sight distance from a line-of-sight position. Namely, the virtual object at the position is in a suspended state.

Operation 332: Acquire, when the plane performance feature of the second placement position meets a plane placement condition, an obstacle placement situation of the second placement position.

The obstacle placement situation is configured to indicate a placement position of an obstacle within a region range corresponding to the second placement position.

Illustratively, when there is an intersection point between the second placement position and the point (that is, the vector ending point) on the perspective range circle (that is, the second placement position and the vector ending point belong to a same position), it is considered that the plane performance feature of the second placement position meets a plane placement condition.

In some embodiments, the obstacle placement situation refers to whether an obstacle exists within the region range corresponding to the second placement position, and if the obstacle exists, a placement position of the obstacle.

In some embodiments, the region range corresponding to the second placement position is acquired; object collision detection is performed based on the virtual object within the region range to obtain an object collision result between the virtual object and the obstacle; and the obstacle placement situation of the second placement position is obtained based on the object collision result.

In this embodiment, the obstacle placement situation of the second placement position is determined by object collision detection. Firstly, the region range corresponding to the second placement position is determined. In some embodiments, the region range is a fixed range preset by the server. Alternatively, the region range is a region range acquired in real time according to an object area of the virtual object. To be specific, if the object area of the virtual object is smaller, a smaller region range is correspondingly acquired, and if the object area of the virtual object is larger, a larger region range is correspondingly acquired. In this case, the region range is a region range larger than or equal to the object area of the virtual object.

After the region range of the virtual object is determined, object collision detection is performed on the virtual object within the region range. During the object collision detection, a collision ray is emitted around by taking an object center of the virtual object as a starting point. If the collision ray is occluded within the region range during occurrence, it indicates that an obstacle exists at the occlusion point. When the obstacle exists, it is detected whether an intersection surface exists between the virtual object and the obstacle. If the intersection surface exists, it indicates that the virtual object may be clipped with the obstacle when placed at the second placement position. Therefore, in this case, the second placement position does not meet the obstacle placement condition. If the intersection surface does not exist, it indicates that the virtual object may not be clipped with the obstacle when placed at the second placement position. The intersection surface between the virtual object and the obstacle is taken as the object collision result, thereby determining the obstacle placement situation within the region range of the second placement position.

Illustratively, refer to FIG. 7 which is a schematic diagram of object collision detection according to an exemplary embodiment of this application. As shown in FIG. 7, a backend test interface 700 is currently displayed, and the backend test interface 700 includes a first virtual scene picture 710 corresponding to a test virtual object and a second virtual scene picture 720 corresponding to a main control virtual target 711. The first virtual scene picture 710 is a scene picture displayed from a perspective of the test virtual object in a same virtual scene as the main control virtual target 711. Therefore, the first virtual scene picture 710 includes the main control virtual target 711. A perspective of the main control virtual target 711 is currently in the second perspective direction. Currently, during object collision detection based on the second placement position, the collision ray is terminated by a door 721 in front of the main control virtual target 711. Therefore, an obstacle door 721 exists within the region range of the second placement position. Moreover, in this case, it is detected that an intersection surface exists between a virtual object 730 and the obstacle door 721 (the virtual object 730 is displayed in black to indicate the existence of the intersection surface), indicating that the second placement position currently does not meet the obstacle placement condition.

Illustratively, when the virtual object meets/does not meet the plane placement condition and meets/does not meet the obstacle placement condition, different placement effects may be displayed in the virtual scene according to the position of the virtual object to remind the user of whether the second placement position currently meets the object placement condition.

In some embodiments, when the second placement position meets the object placement condition, a first placement effect corresponding to the virtual object is displayed; or, when the second placement position does not meet the object placement condition, a second placement effect corresponding to the virtual object is displayed. The first placement effect is different from the second placement effect.

In this embodiment, when both the plane placement condition and the obstacle placement condition belong to the object placement condition, when the second placement position meets the object placement condition, the first placement effect corresponding to the virtual object is displayed, and when the second placement position does not meet the object placement condition, the second placement effect corresponding to the virtual object is displayed. Moreover, the first placement effect and the second placement effect are different effects. In the process of following a change in the perspective direction of the main control virtual target, according to a subsequent change in the placement position, the placement effect is displayed in real time to show whether the placement position currently meets the object placement condition. Namely, the virtual object may present different visual effects to distinguish whether the placement position currently meets the object placement condition.

In an example, different placement effects may be distinguished by different color effects. For example, the first placement effect is displayed in gray, and the second placement effect is displayed in black.

In another example, different placement effects may be distinguished by displaying dotted and solid lines on an edge of the virtual object. For example, the first placement effect is that a solid-line effect is displayed on the edge of the virtual object, and the second placement effect is that a dotted-line effect is displayed on the edge of the virtual object.

In another example, when the second placement position meets the object placement condition, a highlight effect is displayed around the virtual object as the first placement effect; and when the second placement position does not meet the object placement condition, the highlight effect is not displayed.

In another example, when the second placement position meets the object placement condition, the virtual object as a whole displays a highlight effect as the first placement effect; and when an obstacle exists in the region range corresponding to the second placement position and an intersection surface exists between the obstacle and the virtual object at the second placement position, starting from the intersection surface, a translucent effect is displayed in a portion of the virtual object overlapping with the obstacle, and a highlight effect is displayed in a portion not overlapping with the obstacle as the second placement effect. In this case, as the placement position is adjusted, the overlapping portion may also change, so a display region with the translucent effect is also adjusted in real time.

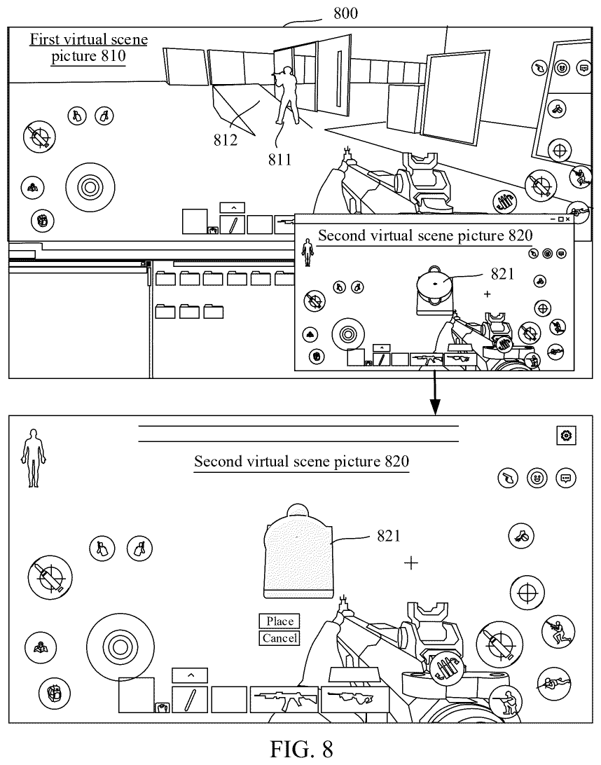

Illustratively, refer to FIG. 8 which is a schematic diagram of a first placement effect according to an exemplary embodiment of this application. For example, the line-of-sight distance between the virtual object and the perspective position of the main control virtual target is fixed. As shown in FIG. 8, a backend test interface 800 is currently displayed, and the backend test interface 800 includes a first virtual scene picture 810 corresponding to a test virtual object and a second virtual scene picture 820 corresponding to a main control virtual target 811. The first virtual scene picture 810 is a scene picture displayed from a perspective of the test virtual object in a same virtual scene as the main control virtual target 811. Therefore, the first virtual scene picture 810 includes the main control virtual target 811. In this case, the main control virtual target 811 is located on a slope 812, the placement position is determined as a point on the slope 812 according to the perspective direction of the main control virtual target 811 at a current moment, which belongs to a same point as a vector ending point corresponding to a perspective distance of the main control virtual target 811, and no obstacle currently exists within the region range corresponding to the placement position. Therefore, in this case, a virtual object 821 meets the object placement condition, and the first placement effect (grayscale effect) is displayed by superimposition on the virtual object 821.

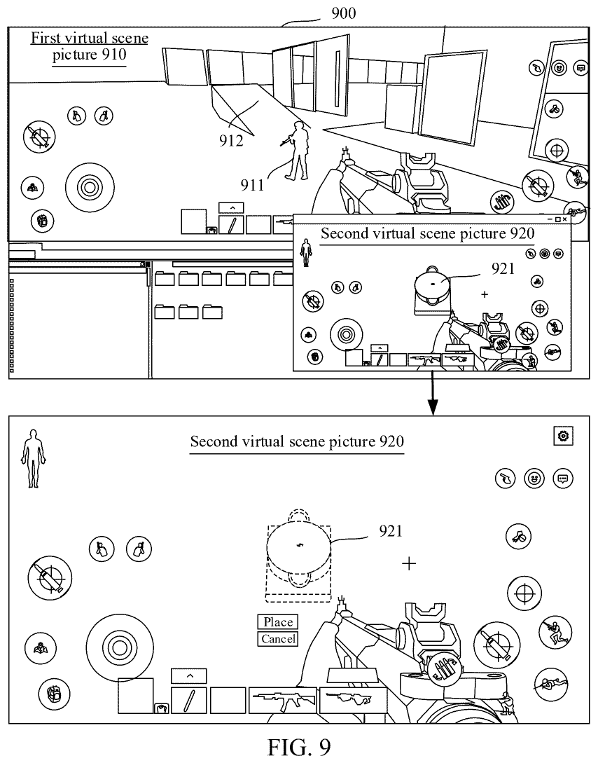

Illustratively, refer to FIG. 9 which is a schematic diagram of a second placement effect according to an exemplary embodiment of this application. For example, the line-of-sight distance between the virtual object and the perspective position of the main control virtual target is fixed. As shown in FIG. 9, a backend test interface 900 is currently displayed, and the backend test interface 900 includes a first virtual scene picture 910 corresponding to a test virtual object and a second virtual scene picture 920 corresponding to a main control virtual target 911. The first virtual scene picture 910 is a scene picture displayed from a perspective of the test virtual object in a same virtual scene as the main control virtual target 911. Therefore, the first virtual scene picture 910 includes the main control virtual target 911. In this case, the main control virtual target 911 is located on a flat ground, a slope 912 exists in a perspective direction of the main control virtual target 911 at a current moment, and the placement position is determined as a point on the slope 912 according to the perspective direction of the main control virtual target 911 at the current moment, which is located above a vector ending point corresponding to a perspective distance of the main control virtual target 911 (in this case, if the virtual object is placed, sinking or clipping may occur). Therefore, in this case, a virtual object 921 meets the object placement condition, and the second placement effect (dotted-line effect) is displayed by superimposition on the virtual object 921.

Operation 333: Place, in response to receiving an object placement operation, the virtual object at an angle matching a plane performance feature of the second placement position when an obstacle placement situation of the second placement position meets an obstacle placement condition.

In some embodiments, an inclination angle between the second placement position and the virtual object is determined based on the plane performance feature of the second placement position; and the virtual object is placed at the second placement position at the inclination angle, and the virtual object fits the plane where the second placement position is located.

Illustratively, when the virtual object meets the object placement condition, an inclination angle between the plane where the second placement position is located and a plane where the main control virtual target is located is determined according to the plane performance feature of the second placement position. For example, if the plane where the second placement position is located and the plane where the main control virtual target is located belong to a same plane, the inclination angle is 0. If the second placement position is a point on a slope with a gradient of 45 degrees and the plane where the main control virtual target is located is a ground plane, the inclination angle between the plane where the second placement position is located and the plane where the main control virtual target is located is 45 degrees.

In this embodiment, after it is determined by perspective ray detection that the second placement position meets the plane placement condition, object collision detection is performed on the second placement position, and after the second placement position meets the obstacle placement condition, the virtual object is placed at the second placement position at an inclination angle matching the plane where the second placement position is located.

In some embodiments, during the perspective ray detection, a distance between a model bottom of the main control virtual target and a model bottom corresponding to the virtual object in a same plane may be set, and a specified range circle is generated by taking the distance as a radius. A circular surface where the specified range circle is located is a plane on which the virtual object may be placed. Then, object collision detection is performed, to prevent an abnormal position problem such as clipping.

In some embodiments, the virtual object corresponds to different display states in different placement states.

In this embodiment, when the virtual object is in a state where the placement position is adjusted, the virtual object corresponds to a first display state, and after the virtual object is placed at the second placement position, the virtual object corresponds to a second display state. For example, when the virtual object is in the state where the placement position is adjusted, the virtual object is in a silhouette state, and after the virtual object is placed at the second placement position, the virtual object is in an actual display state.

Based on the above, in this embodiment, the plane performance feature of the second placement position is acquired, so that the obstacle placement situation of the second placement position is determined when a plane performance condition is met, and it is determined that the second placement position meets the object placement condition when the second placement position meets the obstacle placement condition, which can ensure that no obstacle exists when the second placement position is a position on the plane, improving accuracy of object placement.

In this embodiment, it is determined by perspective ray detection whether the second placement position belongs to a plane position, improving accuracy of plane detection. Moreover, the perspective ray detection may be based on a simple algorithm, improving detection efficiency of plane detection.

In this embodiment, the perspective ray detection is implemented by determining a fixed line-of-sight distance, which can prevent suspension or sinking in the virtual object, thereby improving accuracy of placement of the virtual object.

In this embodiment, the obstacle placement situation within the region range corresponding to the second placement position is determined by object collision detection, which can prevent clipping in the virtual object, thereby improving accuracy of placement of the virtual object.

In this embodiment, when the second placement position meets the object placement condition, the inclination angle between the second placement position and the virtual object is determined according to the plane performance feature of the second placement position, so as to place the virtual object at the second placement position at the inclination angle, so that the virtual object can accurately fit the second placement position, improving accuracy of placement of the virtual object.

In this embodiment, different placement effects are displayed according to a situation between the virtual object and the object placement condition, which can remind the player of whether the virtual object can currently be placed at the second placement position and has a certain reminder function to prevent an invalid operation caused by an placement operation performed by the player when placement cannot be performed at the position.

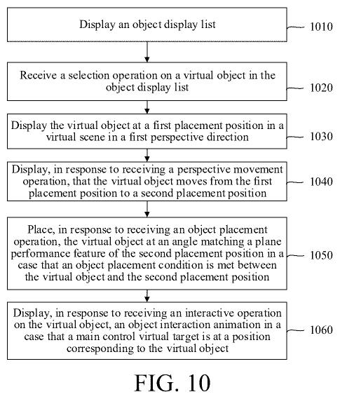

In some embodiments, after the virtual object is placed, the main control virtual target can further interact with the virtual object. Illustratively, refer to FIG. 10 which is a flowchart of a virtual object placement method according to an exemplary embodiment of this application. As shown in FIG. 10, the method includes the following operations.

Operation 1010: Display an object display list.

The object display list includes at least two candidate virtual objects. A quantity of display cells occupied by each of the candidate virtual objects in the object display list is positively correlated with an object size of the candidate virtual object.

Illustratively, the virtual object is an object owned by the main control virtual target. Therefore, when the main control virtual target performs placement position adjustment on the virtual object, the object display list is displayed on the terminal. The object display list is configured to display the at least two candidate virtual objects that may currently be selected for placement position adjustment.

In some embodiments, the object display list refers to a backpack content display list corresponding to a virtual backpack owned by the main control virtual target; or the object display list refers to a shortcut display list currently exists in the interface. When the object display list is the backpack content display list, the object display list is displayed by a trigger operation on the virtual backpack.

Illustratively, the object display list includes a plurality of display cells, and the quantity of display cells occupied by each of the candidate virtual objects is displayed according to the object size of the candidate virtual object. For example, an object a occupies 4 display cells, and an object b occupies 2 display cells. Therefore, a display size of the object a is larger than that of the object b.

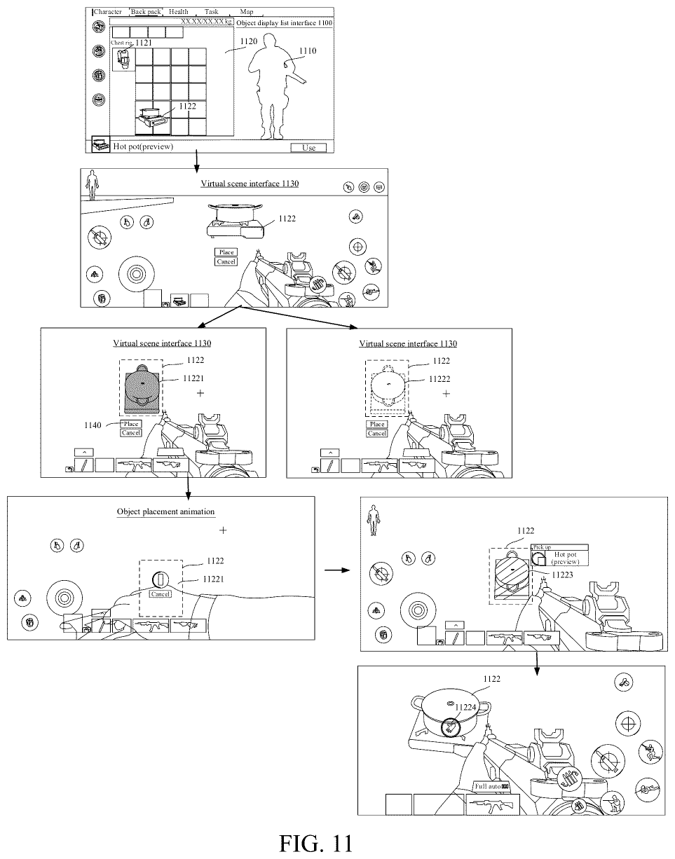

Illustratively, refer to FIG. 11 which is a schematic diagram of a virtual object placement method according to an exemplary embodiment of this application. An object display list interface 1100 is currently displayed. The object display list interface 1100 includes a main control virtual target 1110 and a display list 1120. The display list 1120 includes a candidate virtual object 1121 and a candidate virtual object 1122. The candidate virtual object 1121 occupies 1 display cell, and the candidate virtual object 1122 occupies 4 display cells.

Alternatively, the quantities of display cells occupied by the at least two candidate virtual objects respectively are the same. For example, the object a occupies 2 display cells, and the object b occupies 2 display cells. Therefore, the display size of the object a is equal to that of the object b.

Operation 1020: Receive a selection operation on a virtual object in the object display list.

Illustratively, as shown in FIG. 11, a trigger operation on the candidate virtual object 1122 is received in the display list 1120, and the candidate virtual object 1122 is taken as a selected virtual object.

After the selection operation, a virtual object at a first placement position in a virtual scene is displayed in a first perspective direction; or after the selection operation, a confirmation operation on the virtual object is received; and in response to the confirmation operation, the virtual object at the first placement position in the virtual scene is displayed in the first perspective direction.

Operation 1030: Display the virtual object at a first placement position in a virtual scene in a first perspective direction.

The virtual object is an object which is controlled by the main control virtual target for placement position adjustment in the virtual scene, and the first placement position corresponds to the first perspective direction.

Illustratively, after the virtual object is selected from the object display list, the virtual object at the first placement position in the virtual scene is currently displayed in the first perspective direction.

Illustratively, referring to FIG. 11, after the candidate virtual object 1122 is selected as the virtual object from the display list 1120, a virtual scene interface 1130 is displayed. The virtual scene interface 1130 is a picture in which the virtual scene is observed in the first perspective direction. The candidate virtual object 1122 is displayed at the first placement position in the virtual scene interface 1130.

Operation 1040: Display, in response to receiving a perspective movement operation, that the virtual object moves from the first placement position to a second placement position.

The perspective movement operation is configured to rotate a perspective direction in which the virtual scene is observed from the first perspective direction to a second perspective direction, the virtual object moves synchronously in the virtual scene along with rotation of the perspective direction, and the second placement position corresponds to the second perspective direction.

Illustratively, in a process of receiving the perspective movement operation to rotate the perspective direction of the main control virtual target, perspective ray detection and object collision detection are performed on the virtual object, so as to determine whether a placement position corresponding to the perspective direction at a current moment meets the plane placement condition and the obstacle placement condition. When the placement position meets both the plane placement condition and the obstacle placement condition, the first placement effect corresponding to the virtual object is displayed; and if the placement position does not meet at least one of the plane placement condition and the obstacle placement condition, the second placement effect corresponding to the virtual object is displayed.

Illustratively, as shown in FIG. 11, if the second placement position currently meets the plane placement condition and the obstacle placement condition, a first placement effect 11221 is displayed on the candidate virtual object 1122, and if the second placement position currently does not meet at least one of the plane placement condition and the obstacle placement condition, a second placement effect 11222 is displayed on the candidate virtual object 1122.

Operation 1050: Place, in response to receiving an object placement operation, the virtual object at an angle matching a plane performance feature of the second placement position when an object placement condition is met between the virtual object and the second placement position.

Illustratively, when the first placement effect corresponding to the virtual object is displayed, it indicates that the object placement condition is currently met between the virtual object and the second placement position, and after the object placement operation is received, a placement posture of the main control virtual target is determined, so as to display an object placement animation of the main control virtual target.

The object placement animation refers to an animation in which the main control virtual target places the virtual object at the angle matching the plane performance feature of the second placement position.

Illustratively, as shown in FIG. 11, when the object placement condition is currently met between the candidate virtual object 1122 and the second placement position, a place control 1140 is displayed, and when a trigger operation on the place control 1140 is received as the object placement operation, the object placement animation is displayed, and finally a placement completion state 11223 of the candidate virtual object 1122 placed at the second placement position is displayed (indicated by a diagonal line).

In some embodiments, the placement posture of the main control virtual target when placing the virtual object is a preset fixed posture; or the placement posture of the main control virtual target when placing the virtual object may be adjusted in real time according to an angle of the plane performance feature of the second placement position.

In some embodiments, in response to receiving the object placement operation, a position deviation between the angle matching plane performance feature of the second placement position and a position of the main control virtual target is determined; based on the position deviation, an object placement posture of the main control virtual target is determined at the angle matching plane performance feature of the second placement position; and it is displayed that the main control virtual target places the virtual object at the second placement position in the object placement posture.

In this embodiment, the position deviation refers to an angle difference, a height difference, or the like between the angle of the second placement position and the main control virtual target. For example, the main control virtual target is located on a ground, and the second placement position is a position on a slope with a gradient of 45 degrees. Therefore, the position deviation is at a deviation angle of 45 degrees. Therefore, according to the deviation angle of 45 degrees, the object placement posture of the main control virtual target is determined to be “slant”, so that the virtual object is placed at the second placement position with the “slant” posture when the virtual object is placed subsequently.

Illustratively, there is a corresponding relationship between the position deviation and the object placement posture of the main control virtual target. A posture data file is pre-stored. Position deviations and object placement postures in a corresponding relationship are stored in the posture data file. After the position deviation is determined, the object placement posture corresponding to the position deviation is acquired from the posture data file. For example, when there is a deviation angle, the object placement posture is “slant”. If the second placement position is higher than the perspective position of the main control virtual target, the object placement posture is “raise a hand to place”. If the second placement position is lower than the perspective position of the main control virtual target, the object placement posture is “crouch down to place”.

Operation 1060: Display, in response to receiving an interactive operation on the virtual object, an object interaction animation when a main control virtual target is at a position corresponding to the virtual object.

The interactive operation is configured to instruct the main control virtual target to use the virtual object. The object interaction animation refers to an animation in which an interactive effect is produced after the main control virtual target uses the virtual object.

Illustratively, during completion of placement of the virtual object, when at the position corresponding to the virtual object, the main control virtual target may interact with the virtual object, thereby displaying a process of interaction between the main control virtual target and the virtual object.

In this embodiment, the interactive effect is implemented as a buff effect that may be produced by the main control virtual target after using the virtual object; or a buff effect produced on a teammate virtual target.

Illustratively, as shown in FIG. 11, when the candidate virtual object 1122 is placed at the second placement position, an interactive effect 11224 is displayed on the candidate virtual object 1122, and when a trigger operation on the interactive effect 11224 is received, an animation in which the main control virtual target 1110 interacts with the candidate virtual object 1122 is displayed.

Based on the above, in this embodiment, by displaying the object display list, the main control virtual target can adjust the position of the virtual object owned, and a selection effect of the player is achieved by selecting one from a plurality of objects, improving interactivity and improving diversity of selection of object position adjustment.

In this embodiment, after the virtual object is placed, the main control virtual target can interact with the virtual object, which improves interactivity between the player and the object in the virtual scene and improves diversity of interactions.

In this embodiment, the placement posture is determined by the position deviation, so that the main control virtual target adapts to object placement animations under various situations, improving adaptability between an object placement action and an action of the virtual target.

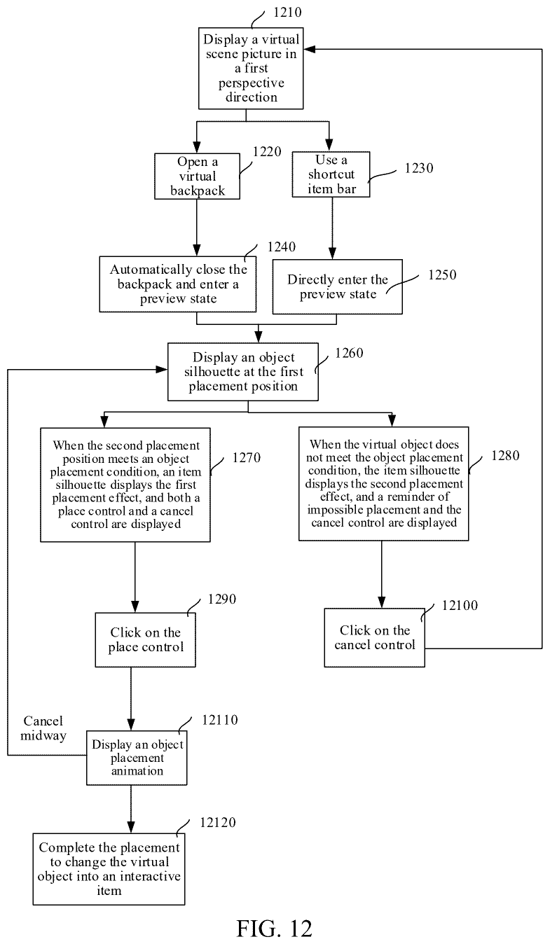

In some embodiments, refer to FIG. 12 which is a flowchart of a virtual object placement method according to an exemplary embodiment of this application. For example, the method is applied to a first-person game scene. As shown in FIG. 12, the method includes the following operations.

Operation 1210: Display a virtual scene picture in a first perspective direction.

A target account is logged on to the terminal during running of a target game. The terminal displays a running interface. The running interface is displayed in a first-person perspective, and the virtual scene picture is displayed in the first perspective direction of the main control virtual target controlled by the target account.

Operation 1220: Open a virtual backpack.

The user may select the virtual object for placement position adjustment through two possible manners: operation 1220 and operation 1240.

When the virtual object is implemented as a virtual object in the virtual backpack of the main control virtual target, an object display list corresponding to the virtual backpack is displayed by triggering the virtual backpack, a trigger operation is performed on a virtual object in the object display list, and the virtual object is selected.

Operation 1230: Automatically close the backpack and enter a preview state.

After the virtual object is selected, the terminal displays that the virtual backpack is automatically closed, and displays that the virtual object is currently in the preview state. The preview state means that the virtual object is currently in a silhouette state.

Operation 1240: Use a shortcut item bar.

When the virtual object is implemented as an object available in the shortcut item bar, the shortcut item bar is displayed on the interface of the terminal, and after a trigger operation is performed on the virtual object in the shortcut item bar, the virtual object is selected.

Operation 1250: Directly enter the preview state.

After the virtual object is selected, the terminal directly displays that the virtual object is currently in the preview state. The preview state means that the virtual object is currently in the silhouette state.

Operation 1260: Display an object silhouette at the first placement position.

When the virtual object enters the preview state, the corresponding silhouette state may be displayed at the first placement position in the virtual scene picture displayed in the first perspective direction.

Operation 1270: When the second placement position meets an object placement condition, an item silhouette displays the first placement effect, and both a place control and a cancel control are displayed.

When the player performs a perspective movement operation on the main control virtual target to control the main control virtual target to rotate the perspective direction, during the rotation of the perspective direction by the main control virtual target, the virtual object also moves synchronously with the rotation of the perspective direction. During the movement, the server performs perspective ray detection and object collision detection on the placement position where the virtual object is currently located, to determine whether the virtual object currently meets the object placement condition.

When the second placement position meets the object placement condition, the item silhouette displays the first placement effect, and the place control and the cancel control are currently displayed on a game interface. The place control is configured to trigger the main control virtual target to place the virtual object at the second placement position. The cancel control is configured to allow the main control virtual target to cancel a placement operation during the placement.

Operation 1280: When the virtual object does not meet the object placement condition, the item silhouette displays the second placement effect, and a reminder of impossible placement and the cancel control are displayed.

When the second placement position does not meet the object placement condition, the item silhouette displays the second placement effect, and the reminder of impossible placement and the cancel control are currently displayed on the game interface. In this case, after the cancel control is triggered, the virtual object is not displayed in the virtual scene picture.

Operation 1290: Click on the place control.

When the second placement position meets the object placement condition, the place control is clicked on as an object placement operation.

Operation 12100: Click on the cancel control.

When the second placement position does not meet the object placement condition, after the cancel control is triggered, the virtual object is not displayed in the virtual scene picture.

Operation 1210 to operation 12100 above belong to a preview stage.

In addition, in the preview stage, parameters may be modified for a display type of the placement effect, and parameter adjustment may also be performed on the line-of-sight distance between the perspective position of the main control virtual target and the virtual object.

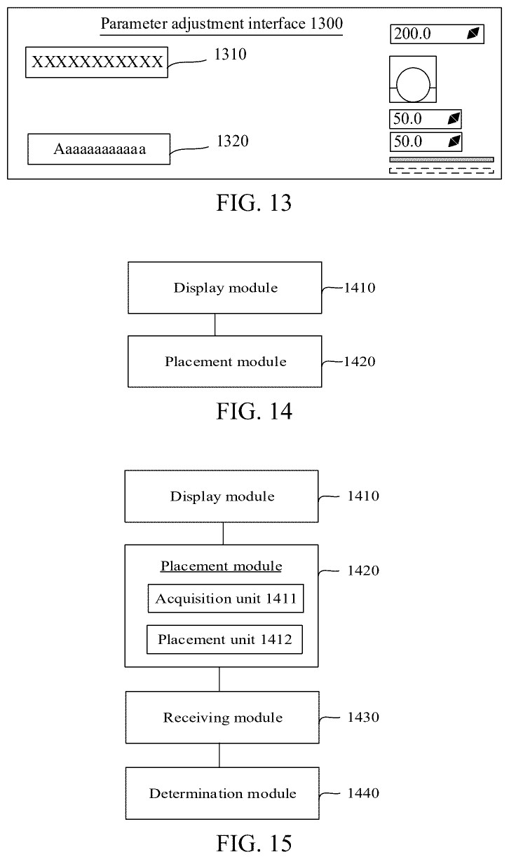

Illustratively, refer to FIG. 13 which is a schematic diagram of parameter adjustment according to an exemplary embodiment of this application. As shown in FIG. 13, a parameter adjustment interface 1300 is currently displayed, including a placement effect parameter adjustment region 1310 and a line-of-sight distance parameter adjustment region 1320. Parameters are modified in the placement effect parameter adjustment region 1310 to display different types of placement effects. Parameters are modified in the line-of-sight distance parameter adjustment region 1320 to display line-of-sight distances with different lengths.

Operation 12110: Display an object placement animation.

After the object placement operation is received, an animation in which the main control virtual target places the virtual object at the second placement position at an angle matching the plane performance feature of the second placement position is displayed as the object placement animation.

If an object placement animation player performs a trigger operation on the cancel control, the object placement animation is not displayed, and the object silhouette is re-displayed.

Operation 12120: Complete the placement to change the virtual object into an interactive item.

After the main control virtual target completes an object placement operation on the virtual object, the virtual object at the second placement position is taken as an interactive item to interact with the main control virtual target, and a buff effect is produced on the main control virtual target.

Operation 12110 to operation 12120 above belong to a placement stage.

In this application, a complex scene space in a game is determined by ray detection and collision detection to ensure that an item may not be at an abnormal position after being placed. Moreover, in an item preview process, in combination with real-time switching of a material color, the player is prompted whether a selected region is a region where the item may be placed.

This application is suitable for first-person mobile phone games where a joystick may be turned in multiple directions to change a perspective; and is suitable for relatively complex scene spaces in current game products. The player can clearly perceive whether the item can be placed during the preview without limiting a perspective rotation operation of the player, and it is ensured that after the player places an item, the item may not appear at an abnormal position in the scene space, ensuring reasonable performance of the game.

FIG. 14 is a structural block diagram of a virtual object placement apparatus according to an exemplary embodiment of this application. As shown in FIG. 14, the apparatus includes:

a display module 1410 configured to display a virtual object at a first placement position in a virtual scene in a first perspective direction, the virtual object being an object in the virtual scene on which placement position adjustment is to be performed, and the first placement position corresponding to the first perspective direction;

the display module 1410 being further configured to display, in response to receiving a perspective movement operation, that the virtual object moves from the first placement position to a second placement position, the perspective movement operation being configured to rotate a perspective direction in which the virtual scene is observed from the first perspective direction to a second perspective direction, the virtual object moving synchronously in the virtual scene along with rotation of the perspective direction, and the second placement position corresponding to the second perspective direction; and a placement module 1420 configured to place, in response to receiving an object placement operation, the virtual object at an angle matching a plane performance feature of the second placement position when an object placement condition is met between the virtual object and the second placement position.

In some embodiments, as shown in FIG. 15, the placement module 1420 includes:

an acquisition unit 1411 configured to acquire, based on the second perspective direction, a plane performance feature of a plane where the second placement position is located;

the acquisition unit 1411 being further configured to acquire, when the plane performance feature meets a plane placement condition, an obstacle placement situation of the second placement position, the obstacle placement situation being configured to indicate a placement position of an obstacle within a region range corresponding to the second placement position; and

a placement unit 1412 configured to place, in response to receiving the object placement operation, the virtual object at the angle matching the plane performance feature of the second placement position when the obstacle placement situation meets an obstacle placement condition.

In some embodiments, the acquisition unit 1411 is further configured to acquire a perspective position of a main control virtual target in the virtual scene; perform perspective ray detection on the second placement position based on the perspective position and the perspective direction to obtain a ray detection result corresponding to the second placement position, the ray detection result being configured to indicate existence of an intersection point between the plane where the second placement position is located and the perspective direction; and obtain the plane performance feature of the second placement position based on the ray detection result.

In some embodiments, the acquisition unit 1411 is further configured to acquire a line-of-sight distance between the perspective position and the virtual object; generate a perspective range region of the main control virtual target based on the second perspective direction by taking the perspective position as a center of a circle and the line-of-sight distance as a radius; and perform perspective ray detection on the second placement position based on the perspective range region to obtain a plane intersection result between the plane where the second placement position is located and the perspective range region, and take the plane intersection result as the ray detection result.

In some embodiments, the acquisition unit 1411 is further configured to acquire the region range corresponding to the second placement position; perform object collision detection based on the virtual object within the region range to obtain an object collision result between the virtual object and the obstacle; and obtain the obstacle placement situation of the second placement position based on the object collision result.

In some embodiments, the placement unit 1412 is further configured to determine an inclination angle between the second placement position and a plane of a position where the main control virtual target is located based on a plane performance feature of a plane where the second placement position is located; and place the virtual object at the second placement position at the inclination angle. The virtual object fits the plane where the second placement position is located.

In some embodiments, the plane performance feature further includes a region area of the plane where the second placement position is located; the acquisition unit 1411 is further configured to determine, based on the region area of the plane where the second placement position is located and areas of a plurality of contact surfaces of the virtual object, a target contact surface from the plurality of contact surfaces; and the placement unit 1412 is further configured to place the virtual object at the second placement position based on the inclination angle and the target contact surface. The target contact surface of the virtual object fits the plane where the second placement position is located.

In some embodiments, the plane performance feature further includes plane friction of the plane where the second placement position is located; and the display module 1410 is further configured to display an object sliding animation when the plane friction meets a friction requirement. The object sliding animation is an animation in which the virtual object slides on the plane where the second placement position is located.

In some embodiments, the display module 1410 is further configured to display a first placement effect corresponding to the virtual object when the second placement position meets the object placement condition; and; or display a second placement effect corresponding to the virtual object when the second placement position does not meet the object placement condition. The first placement effect is different from the second placement effect.

In some embodiments, the apparatus further includes: the display module 1410 further configured to display an object display list, the object display list including at least two candidate virtual objects, a quantity of display cells in the object display list occupied by each of the candidate virtual objects being positively correlated with an object size of the candidate virtual object; and a receiving module 1430 configured to receive a selection operation on a virtual object in the object display list.

In some embodiments, the display module 1410 is further configured to display, in response to receiving an interactive operation on the virtual object, an object interaction animation when a main control virtual target is at a position corresponding to the virtual object. The interactive operation is configured to instruct the main control virtual target to use the virtual object. The object interaction animation is an animation in which an interactive effect is produced after the main control virtual target uses the virtual object.

In some embodiments, the apparatus further includes: a determination module 1440 configured to determine, in response to receiving the object placement operation, a position deviation between the angle matching plane performance feature of the second placement position and a position of the main control virtual target; and determine, based on the position deviation, an object placement posture of the main control virtual target at the angle matching plane performance feature of the second placement position; and the display module 1410 is further configured to display that the main control virtual target places the virtual object at the second placement position in the object placement posture.

In some embodiments, the virtual object corresponds to different display states in different placement states, and the display states include at least one of a placement position adjustment state and a placement position completion state.

In some embodiments, the display module 1410 is further configured to display, in response to receiving the perspective movement operation and based on a perspective rotation angle corresponding to the perspective movement operation, that the virtual object moves from the first placement position to the second placement position. The perspective rotation angle is positively correlated with a position movement distance between the first placement position and the second placement position.

Based on the above, according to the virtual object placement apparatus provided in this embodiment of this application, in the process of displaying the virtual object at the first placement position in the virtual scene in the first perspective direction, when the perspective movement operation is received, as the perspective direction rotates from the first perspective direction to the second perspective direction, it is displayed that the virtual object moves synchronously with the rotation of the perspective direction and finally stays at the second placement position corresponding to the second perspective direction. If the object placement condition is met between the second placement position and the virtual object, after the object placement operation is received, the virtual object is placed at the angle matching the plane performance feature of the second placement position. On the one hand, the virtual object is simultaneously moved to the corresponding placement position through the rotation of the perspective direction, and the movement operation of the perspective direction is merged with the selection operation of the placement position, which improves efficiency of human-computer interaction during the placement of the virtual object. On the other hand, when the placement position meets the object placement condition, after the object placement operation is received, the virtual object is placed at an angle automatically matching a plane performance feature of the placement position, achieving automatic angle matching placement, so that the virtual object can adapt to a more complex virtual scene during the placement, preventing clipping in the virtual object and improving display authenticity during object placement.

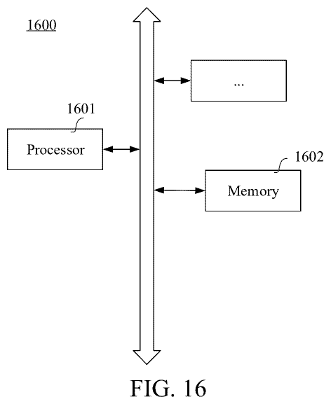

FIG. 16 shows a structural block diagram of a terminal 1600 according to an exemplary embodiment of this application. The terminal 1600 may be a smartphone, a tablet computer, a moving picture experts group audio layer III (MP3) player, a moving picture experts group audio layer IV (MP4) player, a notebook computer, or a desktop computer. The terminal 1600 may also be referred to as another name such as a user equipment, a portable terminal, a laptop terminal, or a desktop terminal.

Generally, the terminal 1600 includes: a processor 1601 and a memory 1602.

The processor 1601 may include one or more processing cores, for example, a 4-core processor or an 8-core processor. The processor 1601 may be implemented in at least one hardware form of a digital signal processor (DSP), a field-programmable gate array (FPGA), and a programmable logic array (PLA). The processor 1601 may also include a main processor and a coprocessor. The main processor is a processor configured to process data in an awake state, and is also referred to as a central processing unit (CPU). The coprocessor is a low-power processor configured to process data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602 may include one or more non-transitory computer-readable storage media. The computer-readable storage medium may be non-transient. The memory 1602 may further include a high-speed random access memory and a nonvolatile memory, for example, one or more disk storage devices or flash storage devices. In some embodiments, the non-transitory computer-readable storage medium in the memory 1602 is configured to store at least one instruction, and the at least one instruction is configured to be executed by the processor 1601 to implement the virtual object placement method provided in the method embodiments of this application.

In some embodiments, the terminal 1600 further includes other components. A person skilled in the art may understand that the structure shown in FIG. 16 constitutes no limitation on the terminal 1600, and the terminal may include more or fewer components than those shown in the figure, or some components may be combined, or a different component deployment may be used.

The computer-readable storage medium stores at least one instruction, at least one program, a code set, or an instruction set. The at least one instruction, the at least one program, the code set, or the instruction set is loaded and executed by the processor to implement the virtual object placement method according to any one of the above embodiments.

What is claimed is:

1. A virtual object placement method performed by a computer device, the method comprising:
displaying a virtual object at a first placement position in a virtual scene in a first perspective direction of a virtual character;
in response to receiving a perspective movement operation of the virtual character from the first perspective direction to a second perspective direction, displaying that the virtual object moves synchronously in the virtual scene from the first placement position to a second placement position corresponding to the second perspective direction according to the perspective movement operation, the virtual object moving, and the second placement position corresponding to the second perspective direction; and
in response to receiving an object placement operation, placing the virtual object at an angle matching a plane performance feature of the second placement position relative to a supporting plane in the virtual scene when an object placement condition is met between the virtual object and the second placement position.

2. The method according to claim 1, wherein the placing the virtual object at an angle matching a plane performance feature of the second placement position in the virtual scene when an object placement condition is met between the virtual object and the second placement position comprises:
acquiring, based on the second perspective direction, a plane performance feature of a plane in the virtual scene where the second placement position is located;
when the plane performance feature meets a plane placement condition, acquiring an obstacle placement situation at the second placement position; and
in response to receiving the object placement operation, placing the virtual object at the angle matching the plane performance feature of the second placement position when the obstacle placement situation meets an obstacle placement condition.

3. The method according to claim 2, wherein the acquiring, based on the second perspective direction, a plane performance feature of a plane in the virtual scene where the second placement position is located comprises:
acquiring a perspective position of a main control virtual target in the virtual scene;
performing perspective ray detection on the second placement position based on the perspective position and the perspective direction to obtain a ray detection result corresponding to the second placement position, the ray detection result being configured to indicate existence of an intersection point between the plane where the second placement position is located and the perspective direction; and
obtaining the plane performance feature of the second placement position based on the ray detection result.

4. The method according to claim 2, wherein the acquiring an obstacle placement situation of the second placement position comprises:
acquiring a region range corresponding to the second placement position;
performing object collision detection based on the virtual object within the region range to obtain an object collision result between the virtual object and the obstacle; and
obtaining the obstacle placement situation of the second placement position based on the object collision result.

5. The method according to claim 1, wherein the placing the virtual object at an angle matching a plane performance feature of the second placement position relative to a supporting plane in the virtual scene comprises:
determining an inclination angle between the second placement position and the virtual object based on a plane performance feature of the supporting plane where the second placement position is located; and
placing the virtual object at the second placement position at the inclination angle, the virtual object fitting the supporting plane where the second placement position is located.

6. The method according to claim 1, wherein the plane performance feature further comprises a region area of the supporting plane where the second placement position is located;
the method further comprises:
determining, based on the region area of the supporting plane where the second placement position is located and areas of a plurality of contact surfaces of the virtual object, a target contact surface from the plurality of contact surfaces; and
placing the virtual object at the second placement position based on the inclination angle and the target contact surface, the target contact surface of the virtual object fitting the supporting plane where the second placement position is located.

7. The method according to claim 1, wherein the plane performance feature further comprises plane friction of the supporting plane where the second placement position is located; and the method further comprises:
displaying an object sliding animation in which the virtual object slides on the supporting plane where the second placement position is located when the plane friction meets a friction requirement.

8. The method according to claim 1, wherein the method further comprises:
displaying a first placement effect corresponding to the virtual object when the second placement position meets the object placement condition; and
displaying a second placement effect corresponding to the virtual object when the second placement position does not meet the object placement condition, the first placement effect being different from the second placement effect.

9. The method according to claim 1, wherein before the displaying a virtual object at a first placement position in a virtual scene in a first perspective direction, the method further comprises:
displaying an object display list, the object display list comprising at least two candidate virtual objects associated with the virtual character, a quantity of display cells in the object display list occupied by each of the candidate virtual objects being positively correlated with an object size of the candidate virtual object; and
receiving a selection operation on the virtual object in the object display list.

10. The method according to claim 1, wherein the method further comprises:
in response to receiving an interactive operation to use the virtual object, displaying an object interaction animation in which an interactive effect is produced after a main control virtual target located at a position corresponding to the virtual object uses the virtual object.

11. The method according to claim 1, wherein the placing the virtual object at an angle matching a plane performance feature of the second placement position relative to a supporting plane in the virtual scene comprises:
determining, in response to receiving the object placement operation, a position deviation between the angle matching plane performance feature of the second placement position and a position of a main control virtual target;
determining, based on the position deviation, an object placement posture of the main control virtual target at the angle matching plane performance feature of the second placement position; and
displaying that the main control virtual target places the virtual object at the second placement position in the object placement posture.

12. The method according to claim 1, wherein the virtual object has different display states in different placement states, the display states comprising a placement position adjustment state and a placement position completion state.

13. The method according to claim 1, wherein the displaying that the virtual object moves synchronously in the virtual scene from the first placement position to a second placement position corresponding to the second perspective direction according to the perspective movement operation comprises:
displaying, in response to receiving the perspective movement operation and based on a perspective rotation angle corresponding to the perspective movement operation, that the virtual object moves from the first placement position to the second placement position, the perspective rotation angle being positively correlated with a position movement distance between the first placement position and the second placement position.

14. A computer device, comprising a processor and a memory, the memory storing at least one program, and the at least one program, when loaded and executed by the processor, causing the computer device to implement a virtual object placement method including:
displaying a virtual object at a first placement position in a virtual scene in a first perspective direction of a virtual character;
in response to receiving a perspective movement operation of the virtual character from the first perspective direction to a second perspective direction, displaying that the virtual object moves synchronously in the virtual scene from the first placement position to a second placement position corresponding to the second perspective direction according to the perspective movement operation, the virtual object moving, and the second placement position corresponding to the second perspective direction; and
in response to receiving an object placement operation, placing the virtual object at an angle matching a plane performance feature of the second placement position relative to a supporting plane in the virtual scene when an object placement condition is met between the virtual object and the second placement position.

15. The computer device according to claim 14, wherein the placing the virtual object at an angle matching a plane performance feature of the second placement position in the virtual scene when an object placement condition is met between the virtual object and the second placement position comprises:
acquiring, based on the second perspective direction, a plane performance feature of a plane in the virtual scene where the second placement position is located;
when the plane performance feature meets a plane placement condition, acquiring an obstacle placement situation at the second placement position; and
in response to receiving the object placement operation, placing the virtual object at the angle matching the plane performance feature of the second placement position when the obstacle placement situation meets an obstacle placement condition.

16. The computer device according to claim 14, wherein the placing the virtual object at an angle matching a plane performance feature of the second placement position relative to a supporting plane in the virtual scene comprises:
determining an inclination angle between the second placement position and the virtual object based on a plane performance feature of the supporting plane where the second placement position is located; and
placing the virtual object at the second placement position at the inclination angle, the virtual object fitting the supporting plane where the second placement position is located.

17. The computer device according to claim 14, wherein the plane performance feature further comprises plane friction of the supporting plane where the second placement position is located; and the method further comprises:
displaying an object sliding animation in which the virtual object slides on the supporting plane where the second placement position is located when the plane friction meets a friction requirement.

18. The computer device according to claim 14, wherein the virtual object has different display states in different placement states, the display states comprising a placement position adjustment state and a placement position completion state.

19. The computer device according to claim 14, wherein the displaying that the virtual object moves synchronously in the virtual scene from the first placement position to a second placement position corresponding to the second perspective direction according to the perspective movement operation comprises:
displaying, in response to receiving the perspective movement operation and based on a perspective rotation angle corresponding to the perspective movement operation, that the virtual object moves from the first placement position to the second placement position, the perspective rotation angle being positively correlated with a position movement distance between the first placement position and the second placement position.

20. A non-transitory computer-readable storage medium, storing at least one program, the at least one program, when loaded and executed by a processor of a computer device, causing the computer device to implement a virtual object placement method including:
displaying a virtual object at a first placement position in a virtual scene in a first perspective direction of a virtual character;
in response to receiving a perspective movement operation of the virtual character from the first perspective direction to a second perspective direction, displaying that the virtual object moves synchronously in the virtual scene from the first placement position to a second placement position corresponding to the second perspective direction according to the perspective movement operation, the virtual object moving, and the second placement position corresponding to the second perspective direction; and
in response to receiving an object placement operation, placing the virtual object at an angle matching a plane performance feature of the second placement position relative to a supporting plane in the virtual scene when an object placement condition is met between the virtual object and the second placement position.
